(19) United States
(12) Patent Application Publication
(10) Pub. No.: US 2025/0072440 A1
(43) Pub. Date: Mar. 6, 2025

(54) STORAGE METHOD, TRANSPORTATION METHOD, STORAGE APPARATUS, AND TRANSPORTATION APPARATUS

(71) Applicant: SHARP KABUSHIKI KAISHA, Sakai City, Osaka (JP)

(72) Inventors: YASUHIRO SHIBAI, Sakai City (JP); Yoshikazu SUGA, Sakai City (JP); Momomi UCHIDA, Sakai City (JP); SHINYA OKAZAKI, Sakai City (JP); Masaki YAMAMOTO, Sakai City (JP)

(21) Appl. No.: 18/825,468

(22) Filed: Sep. 5, 2024

(30) Foreign Application Priority Data
Sep. 6, 2023 (JP) 2023-144719
Jun. 6, 2024 (JP) 2024-092439

(51) Int. Cl. A23B 7/152; A23L 3/26; A23L 3/3445; B01J 23/30; B01J 35/39

(52) U.S. Cl. CPC A23B 7/152; A23B 2/50; A23B 2/721; B01J 23/30; B01J 35/39

(57) ABSTRACT

The present disclosure provides a storage method capable of suppressing damage to at least one of a vegetable, a fruit, a flower, or an ornamental plant stored in a storage, a storage vessel, or a storage bag. The storage method includes a gas supply step of supplying ethylene gas into the storage, the storage vessel, or the storage bag; and an irradiation step of irradiating a photocatalyst in the storage, the storage vessel, or the storage bag storing at least one of a vegetable, a fruit, a flower or an ornamental plant with light, thereby decomposing the ethylene gas.

### BACKGROUND OF THE INVENTION

### Field of the Invention

The present disclosure relates to a storage method, a transportation method, a storage apparatus and a transportation apparatus for at least one of a vegetable, a fruit, a flower or an ornamental plant.

### Description of the Background Art

The growth, ripening, senescence or the like of a plant is controlled by the action of a plant hormone. Ethylene gas, which is a plant hormone, has an effect of promoting the ripening of fruits or vegetables that are fruit, and as the ripening of fruit progresses, the fruit becomes soft and sweet. When the ripening of the fruit progresses too much, the fruit becomes damaged and inedible. Therefore, the ripening of fruit can be controlled by removing or supplying ethylene gas to provide consumers with fruit that is ready to eat. In addition, ethylene gas promotes the senescence of a flower or an ornamental plant.

For example, a freshness-keeping apparatus that removes ethylene gas in a container by an ethylene gas decomposition filter is known (see, for example, JP 2021-188757 A).

### SUMMARY OF THE INVENTION

Conventional methods may not be effective enough to keep freshness.

The present disclosure has been made in view of such circumstances, and provides a storage method, a transportation method, a storage apparatus, and a transportation apparatus capable of suppressing damage to a vegetable, a fruit, a flower, or an ornamental plant.

The present disclosure provides a storage method including: a gas supply step of supplying ethylene gas into a storage, a storage vessel, or a storage bag; and an irradiation step of irradiating a photocatalyst in the storage, the storage vessel, or the storage bag storing at least one of a vegetable, a fruit, a flower, or an ornamental plant with light, thereby decomposing the ethylene gas.

The present disclosure also provides a storage apparatus including: a storage, a storage vessel or a storage bag for storing at least one of a vegetable, a fruit, a flower or an ornamental plant; a photocatalyst placed in the storage, the storage vessel or the storage bag; a light irradiation unit provided to irradiate the photocatalyst with light; and an ethylene gas supply unit that is provided to supply ethylene gas into the storage, the storage vessel or the storage bag.

The present disclosure also provides a transportation method including: a gas supply step of supplying ethylene gas into a cargo compartment, a transportation vessel, or a transportation bag; and an irradiation step of irradiating a photocatalyst in the cargo compartment, the transportation vessel, or the transportation bag accommodating at least one of a vegetable, a fruit, a flower, or an ornamental plant with light, thereby decomposing the ethylene gas.

The present disclosure also provides a transportation apparatus including: a cargo compartment, a transportation vessel or a transportation bag for accommodating at least one of a vegetable, a fruit, a flower, or an ornamental plant; a photocatalyst placed in the cargo compartment, the transportation vessel or the transportation bag; a light irradiation unit that is provided to irradiate the photocatalyst with light; and an ethylene gas supply unit that is provided to supply ethylene gas into the cargo compartment, the transportation vessel or the transportation bag.

According to the present disclosure, it is possible to suppress damage to a vegetable, a fruit, a flower, or an ornamental plant.

### BRIEF DESCRIPTION OF THE DRAWINGS

FIG. 1 is a schematic view of a storage apparatus according to an embodiment of the present disclosure.

FIG. 2 is a schematic view of a transportation apparatus according to an embodiment of the present disclosure.

FIG. 3 is Table 1 showing the evaluation criteria for visual appearance inspection and finger touch.

FIG. 4 is Table 2 showing the relationship between the visual appearance evaluation, the finger touch evaluation, and the overall evaluation.

FIG. 5 is Table 3 showing the test condition and evaluation result of Reference Example 1, Working Example 1, and Comparative Examples 1 and 2 in which tomatoes were used as test subjects.

FIG. 6 is Table 4 showing the test condition and evaluation result of Reference Example 2 and Working Examples 2 to 6 in which tomatoes were used as test subjects.

FIG. 7 is Table 5 showing the test condition and evaluation result of Reference Example 3, Working Example 7, and Comparative Examples 3 and 4 in which peaches were used as test subjects.

FIG. 8 is Table 6 showing the number of days to petal detachment or bent neck (number of freshness-keeping days), the ethylene gas concentration in the acrylic box at the end of storage, the evaluation on the freshness keeping of the flower, and the like.

### DESCRIPTION OF THE PREFERRED EMBODIMENTS

A storage method according to the present disclosure includes: a gas supply step of supplying ethylene gas into a storage, a storage vessel, or a storage bag; and an irradiation step of irradiating a photocatalyst in the storage, the storage vessel, or the storage bag storing a vegetable, a fruit, a flower, or an ornamental plant with light, thereby decomposing the ethylene gas.

A concentration of the ethylene gas in the storage, the storage vessel, or the storage bag into which the ethylene gas is supplied is preferably from 5 ppm to 160 ppm.

The irradiation step is preferably a step of irradiating the photocatalyst with light at least until the ethylene gas concentration in the storage, the storage vessel, or the storage bag becomes 2 ppm or less.

The photocatalyst preferably includes tungsten oxide.

The present disclosure also provides a storage apparatus including: a storage, a storage vessel or a storage bag for storing a vegetable, a fruit, a flower, or an ornamental plant; a photocatalyst placed in the storage, the storage vessel or the storage bag; a light irradiation unit provided to irradiate the photocatalyst with light; and an ethylene gas supply unit that is provided to supply ethylene gas into the storage, the storage vessel or the storage bag.

The present disclosure also provides a transportation method including: a gas supply step of supplying ethylene gas into a cargo compartment, a transportation vessel, or a transportation bag; and an irradiation step of irradiating a photocatalyst in the cargo compartment, the transportation vessel, or the transportation bag accommodating at least one of a vegetable, a fruit, a flower or an ornamental plant with light, thereby decomposing the ethylene gas.

The present disclosure also provides a transportation apparatus including: a cargo compartment, a transportation vessel or a transportation bag for accommodating at least one of a vegetable, a fruit, a flower, or an ornamental plant; a photocatalyst placed in the cargo compartment, the transportation vessel or the transportation bag; a light irradiation unit that is provided to irradiate the photocatalyst with light; and an ethylene gas supply unit that is provided to supply ethylene gas into the cargo compartment, the transportation vessel or the transportation bag.

Hereinafter, an embodiment of the present disclosure will be described with reference to drawings. The configurations shown in the drawings and the following description are merely examples, and the scope of the present disclosure is not limited to those shown in the drawings or the following description.

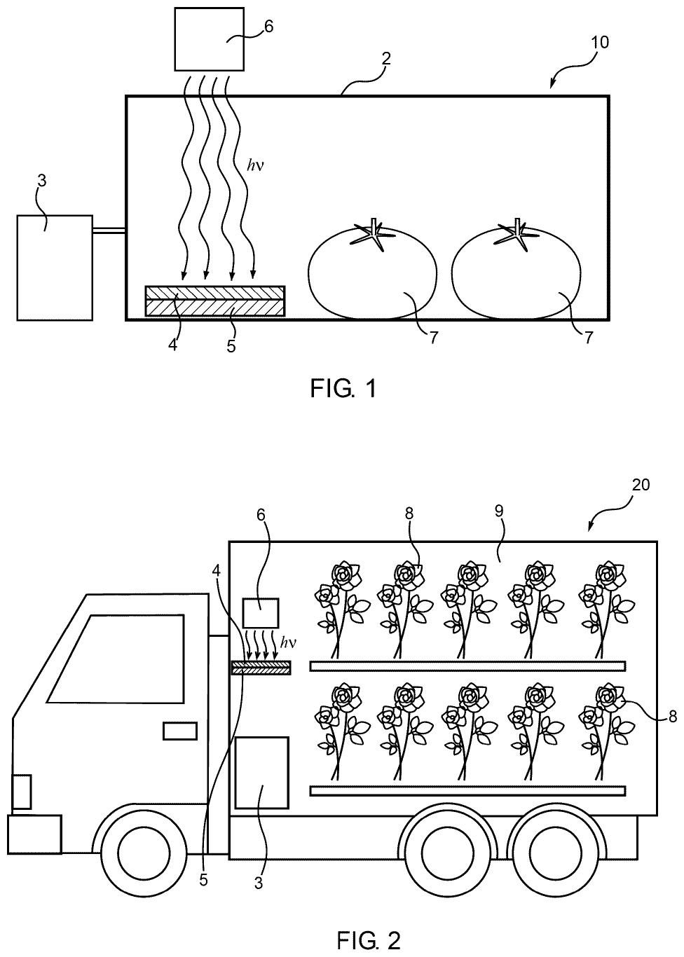

FIG. 1 is a schematic view of a storage apparatus according to the present embodiment. FIG. 2 is a schematic view of a transportation apparatus according to the present embodiment.

The storage method according to the present embodiment includes: a gas supply step of supplying ethylene gas into a storage 2, a storage vessel 2, or a storage bag 2; and an irradiation step of irradiating a photocatalyst 4 in the storage 2, the storage vessel 2, or the storage bag 2 storing at least one of a vegetable, a fruit, a flower 8, or an ornamental plant with light, thereby decomposing the ethylene gas. The storage method according to the present embodiment is a method of storing at least one of the vegetable, the fruit, the flower 8 or the ornamental plant into the storage 2, the storage vessel 2, or the storage bag 2. The storage method according to the present embodiment may be a method of keeping freshness of the vegetable, the fruit, the flower or the ornamental plant.

A storage apparatus 10 according to the present embodiment includes: the storage 2, the storage vessel 2 or the storage bag 2 for storing at least one of the vegetable, the fruit, the flower 8, or an ornamental plant; the photocatalyst 4 placed in the storage 2, the storage vessel 2 or the storage bag 2; a light irradiation unit 6 provided to irradiate the photocatalyst 4 with light; and an ethylene gas supply unit 3 that is provided to supply ethylene gas into the storage 2, the storage vessel 2 or the storage bag 2. The storage apparatus 10 according to the present embodiment may be a freshness-keeping apparatus.

The transportation method according to the present disclosure includes: a gas supply step of supplying ethylene gas into a cargo compartment 9, a transportation vessel, or a transportation bag; and an irradiation step of irradiating a photocatalyst in the cargo compartment 9, the transportation vessel, or the transportation bag accommodating at least one of a vegetable, a fruit, a flower 8, or an ornamental plant with light, thereby decomposing the ethylene gas.

A transportation apparatus 20 according to the present disclosure includes: the cargo compartment 9, a transportation vessel or a transportation bag for accommodating at least one of a vegetable, a fruit, the flower 8, or the ornamental plant; the photocatalyst 4 placed in the cargo compartment 9, the transportation vessel or the transportation bag; a light irradiation unit 6 that is provided to irradiate the photocatalyst 4 with light; and an ethylene gas supply unit 3 that is provided to supply ethylene gas into the cargo compartment 9, the transportation vessel or the transportation bag.

Examples of the vegetable or the fruit, which is an object to be stored or transported, may include climacteric fruits, such as tomatoes, peaches, avocados, pears, bananas, apricots, melons, mangoes, papayas, kiwis, etc. In the storage apparatus 10 shown in FIG. 1, the object to be stored is tomato 7.

In addition, the flower 8 or the ornamental plant, which is an object to be stored or transported, may be a cut flower, such as Dianthus caryophyllus, Gypsophila elegans, Lathyrus odoratus, Antirrhinum majus, Eustoma, a rose, Narcissus, Chrysanthemum morifolium, Tulipa gesneriana, Lilium, etc. In the transportation apparatus 20 shown in FIG. 2, the object to be transported is a rose (flower 8).

A storage period for the vegetable, the fruit, the flower 8, or an ornamental plant in the storage 2, the storage vessel 2, the storage bag 2, the cargo compartment 9, the transportation vessel, or the transportation bag varies depending on the object to be stored or transported, and is, for example, from 1 day to 60 days, and preferably from 1 day to 11 days.

In addition, a temperature inside the storage 2, the storage vessel 2, the storage bag 2, the cargo compartment 9, the transportation vessel, or the transportation bag during the storage period for the vegetable, the fruit, the flower 8, or the ornamental plant in storage 2, the storage vessel 2, the storage bag 2, the cargo compartment 9, the transportation vessel or the transportation bag can be set to a temperature from 2° C. to 35° C.

The storage 2 (storage chamber) is, for example, a warehouse, a container, a cargo compartment of an automobile, a refrigerator, a storehouse, or the like. The storage vessel 2 is a vessel for storing the vegetable, the fruit, the flower 8, or the ornamental plant. The storage bag 2 is a bag for storing the vegetable, the fruit, the flower 8, or the ornamental plant. The inner space of the storage 2, the storage vessel 2, or the storage bag 2 may be an enclosed space, a closed space, or a sealed space. An internal gas in the storage 2, the storage vessel 2, or the storage bag 2 may be air.

The storage 2, the storage vessel 2, or the storage bag 2 may have a transparent portion. This makes it possible to irradiate light from the light irradiation unit 6 placed outside the storage 2, the storage vessel 2, or the storage bag 2 onto the photocatalyst 4 placed inside the storage 2, the storage vessel 2, or the storage bag 2 through the transparent portion.

The cargo compartment 9 is, for example, a cargo compartment of a truck, a cargo compartment of an automobile, a cargo compartment of a ship, a cargo compartment of a train, a cargo compartment of an electric train, a cargo compartment of a cargo vehicle, a cargo compartment of an airplane, or the like.

The transportation vessel is, for example, a marine container, a railroad container, a truck container, or the like.

Ethylene gas (ethene) is an organic chemical with the chemical formula CH₂=CH₂. In the gas supply step, the ethylene gas from the ethylene gas supply unit 3 is supplied into the storage 2, the storage vessel 2, the storage bag 2, the cargo compartment 9, the transportation vessel, or the transportation bag. This makes it possible for the internal gas of the storage 2, the storage vessel 2, the storage bag 2, the cargo compartment 9, the transportation vessel, or the transportation bag to be air including the ethylene gas. The internal gas including oxygen gas enables oxidative decomposition of the ethylene gas by photocatalytic activity.

The ethylene gas supply unit 3 includes, for example, an ethylene gas cylinder, an ethylene gas canister, a chemical generation source (e.g., a generation source provided to generate ethylene gas by a dehydration reaction of ethanol), a mature climacteric fruit, or the like.

The ethylene gas supply unit 3 may be placed outside the storage 2, the storage vessel 2, the storage bag 2, the cargo compartment 9, the transportation vessel, or the transportation bag, and may be provided to inject ethylene gas into the storage 2, the storage vessel 2, the storage bag 2, the cargo compartment 9, the transportation vessel, or the transportation bag. In addition, the ethylene gas supply unit 3 may be provided to inject ethylene gas diluted with air into the storage 2, the storage vessel 2, the storage bag 2, the cargo compartment 9, the transportation vessel, or the transportation bag. In addition, the ethylene gas supply unit 3 can be provided to control an injection amount, an ethylene concentration of the injected gas, or the like in order to control the ethylene gas concentration inside the storage 2, the storage vessel 2, the storage bag 2, the cargo compartment 9, the transportation vessel, or the transportation bag.

The ethylene gas supply unit 3 may be placed inside the storage 2, the cargo compartment 9, or the transportation vessel. In this case, the ethylene gas supply unit 3 can be provided to control a supply amount of ethylene gas, an ethylene concentration of the supplied gas, or the like in order to control the ethylene gas concentration inside the storage 2, the cargo compartment 9, or the transportation vessel.

An ethylene gas concentration (initial ethylene gas concentration) in the storage 2, the storage vessel 2, the storage bag 2, the cargo compartment 9, the transportation vessel, or the transportation bag into which the ethylene gas is supplied from the ethylene gas supply unit 3 in the gas supply step is preferably from 5 ppm to 160 ppm, more preferably from 8 ppm to 80 ppm. Thus, the ethylene gas supplied into the storage 2, the storage vessel 2, the storage bag 2, the cargo compartment 9, the transportation vessel, or the transportation bag in the gas supply step can be rapidly oxidatively decomposed by the photocatalytic activity, which can suppress the ripening of the vegetable or the fruit or the senescence of the flower 8 or the ornamental plant due to the supplied ethylene gas. As a result, it is possible to suppress damage to the vegetable, the fruit, the flower 8, or an ornamental plant. In addition, it is considered that the oxidative decomposition product of ethylene gas suppresses the ripening of the vegetable or the fruit or the senescence of the flower 8 or the ornamental plant, and a sufficient amount of the oxidative decomposition product can be produced.

The photocatalyst 4 is placed inside the storage 2, the storage vessel 2, the storage bag 2, the cargo compartment 9, the transportation vessel or the transportation bag. The photocatalyst 4 may be a photocatalyst layer provided on a base material 5, may be photocatalyst powder, or may be a photocatalyst porous body. The photocatalyst 4 may include, for example, tungsten oxide (WO₃), titanium oxide (TiO₂), or the like. In addition, the photocatalyst 4 may include tungsten oxide particles carrying a co-catalyst such as platinum or titanium oxide particles carrying a co-catalyst. The tungsten oxide or titanium oxide may have a composition that deviates from the stoichiometric composition as long as it has photocatalytic activity. The photocatalyst preferably includes tungsten oxide. This makes it possible to generate photocatalytic activity by irradiating LED light onto the photocatalyst 4.

The light irradiation unit 6 is a portion provided to be able to irradiate the photocatalyst 4 placed in the storage 2, the storage vessel 2, the storage bag 2, the cargo compartment 9, the transportation vessel, or the transportation bag with light. By irradiating the photocatalysts 4 with light, the photocatalytic activity can be generated, and the photocatalytic activity allows the oxidative decomposition of the ethylene gas in the storage 2, the storage vessel 2, the storage bag 2, the cargo compartment 9, the transportation vessel, or the transportation bag. The light irradiation unit 6 can include, for example, a white LED lamp, a blue LED lamp, a fluorescent lamp, or an incandescent lamp as a light emission unit.

The light irradiation unit 6 may be placed outside the storage 2, the storage vessel 2, the storage bag 2, the cargo compartment 9, the transportation vessel, or the transportation bag. In this case, the light from the light irradiation unit 6 is irradiated onto the photocatalyst 4 through a transparent portion of the storage 2, the storage vessel 2, the storage bag 2, the cargo compartment 9, the transportation vessel, or the transportation bag.

In addition, the light irradiation unit 6 may be placed inside the storage 2, the storage vessel 2, the storage bag 2, the cargo compartment 9, the transportation vessel, or the transportation bag.

The irradiation step is a step of irradiating the photocatalyst 4 in the storage 2, the storage vessel 2, the storage bag 2, the cargo compartment 9, the transportation vessel, or the transportation bag that stores the vegetable, the fruit, the flower 8, or the ornamental plant with light, thereby decomposing ethylene gas. In this step, the ethylene gas supplied into the storage 2, the storage vessel 2, the storage bag 2, the cargo compartment 9, the transportation vessel, or the transportation bag in the gas supply step is oxidatively decomposed by the photocatalytic activity. It is considered that the oxidative decomposition product of the ethylene gas suppresses the ripening of the vegetable or the fruit or the senescence of the flower 8 or the ornamental plant. In addition, in the irradiation step, the ethylene gas generated from the vegetable or the fruit to be stored may be oxidatively decomposed by the photocatalytic activity.

In the irradiation step, the light irradiation unit 6 can irradiate the photocatalyst 4 with light at least until the ethylene gas concentration in the storage 2, the storage vessel 2, the storage bag 2, the cargo compartment 9, the transportation vessel, or the transportation bag becomes 2 ppm or less. This makes it possible to suppress the ripening of the vegetable or the fruit or the senescence of the flower 8 or the ornamental plant due to the ethylene gas and to suppress the damage to the vegetable, the fruit, the flower 8, or the ornamental plant. In addition, the light irradiation unit 6 can irradiate the photocatalyst 4 with light so that the ethylene gas concentration in the storage 2, the storage vessel 2, the storage bag 2, the cargo compartment 9, the transportation vessel, or the transportation bag is maintained to be 2 ppm or less during the storage period for the vegetable, the fruit, the flower 8 or the ornamental plant, which is an object to be stored or transported. The light irradiation unit 6 may continuously irradiate the photocatalyst 4 with light or may intermittently irradiate the photocatalyst 4 with light.

### Storage Test 1

Storage tests of Working Examples 1 to 7, Comparative Examples 1 to 4, and Reference Examples 1 to 3 were conducted to evaluate the freshness of tomatoes or peaches after storage.

First, an amount of a photocatalyst dispersion liquid (0.7 wt % Pt—WO₃ dispersion liquid) with a solid content of 0.7 g was placed in a petri dish to make the liquid layer of the photocatalyst dispersion liquid uniform in thickness. Then, the liquid layer of the photocatalyst dispersion liquid was dried at 90° C. for 1 hour to form a photocatalyst layer in the petri dish.

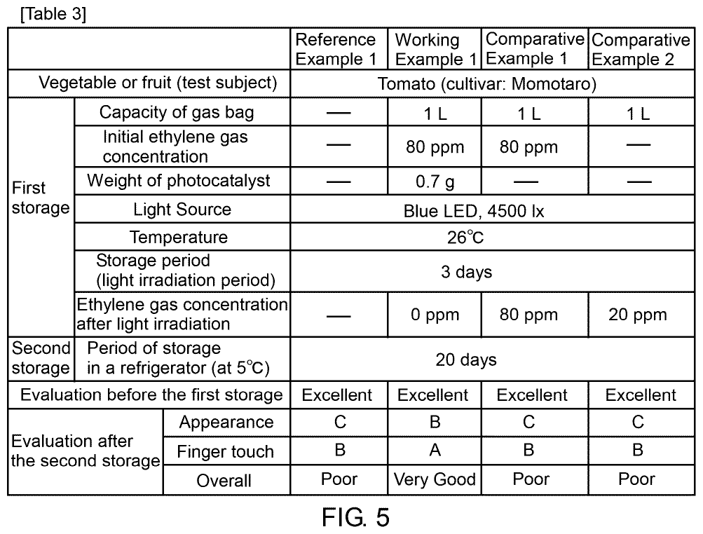

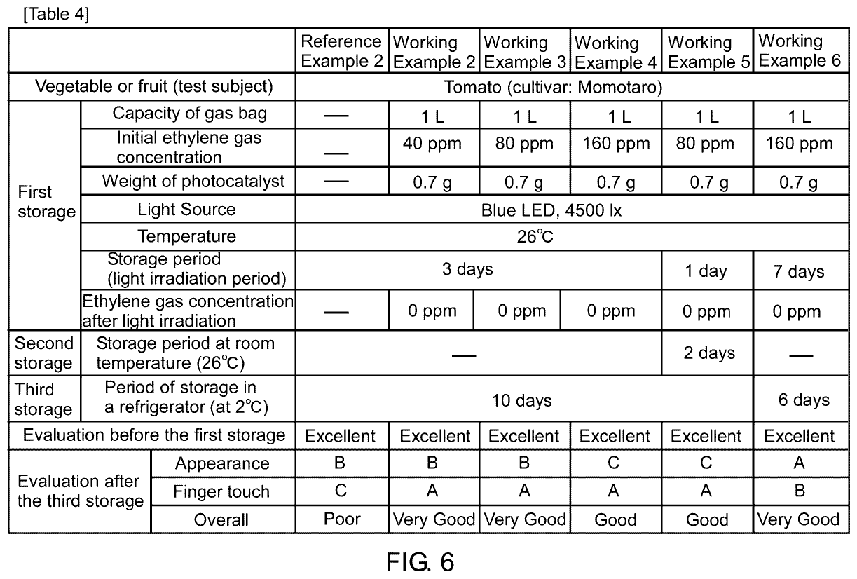

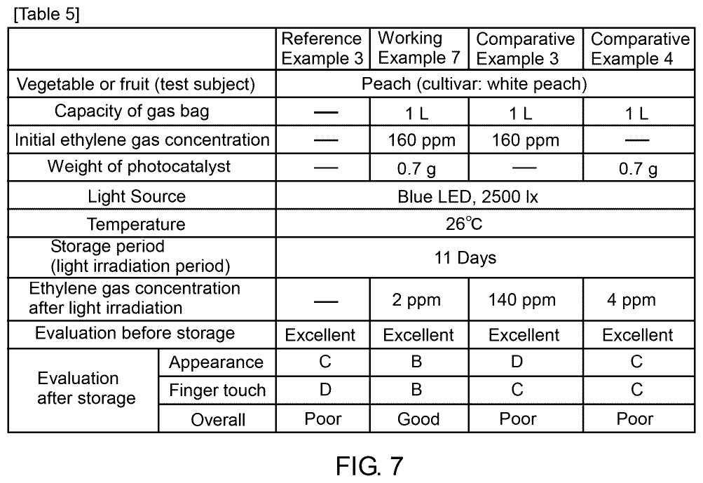

One tomato or one peach and the petri dish with the photocatalyst layer were placed in a 1 L transparent gas bag, ethylene gas diluted with dry air to the concentration shown in Tables 3 to 5 (initial ethylene gas concentration) was injected into the gas bag and the gas bag was enclosed. The gas bag was irradiated with blue LED light for the period shown in Table 3 of FIG. 5, Table 4 of FIG. 6 and Table 5 of FIG. 7 so that the photocatalyst layer in the gas bag was irradiated with the light (first storage). In addition, the ethylene gas concentration of the gas in the gas bag at the end of the first storage was measured.

In the test shown in Table 3 of FIG. 5, the tomato taken from the gas bag after the first storage was subjected to a second storage. In the test shown in Table 4 of FIG. 6, the tomato taken from the gas bag after the first storage was subjected to a third storage or to both of the second storage and the third storage.

After the storage, these tomatoes or peaches were evaluated for freshness using visual appearance inspection and finger touch.

In addition, a similar evaluation was also performed before the tomatoes or peaches were placed in the gas bag prior to the first storage.

The tomatoes or peaches tested were approximately the similar color, shape and size.

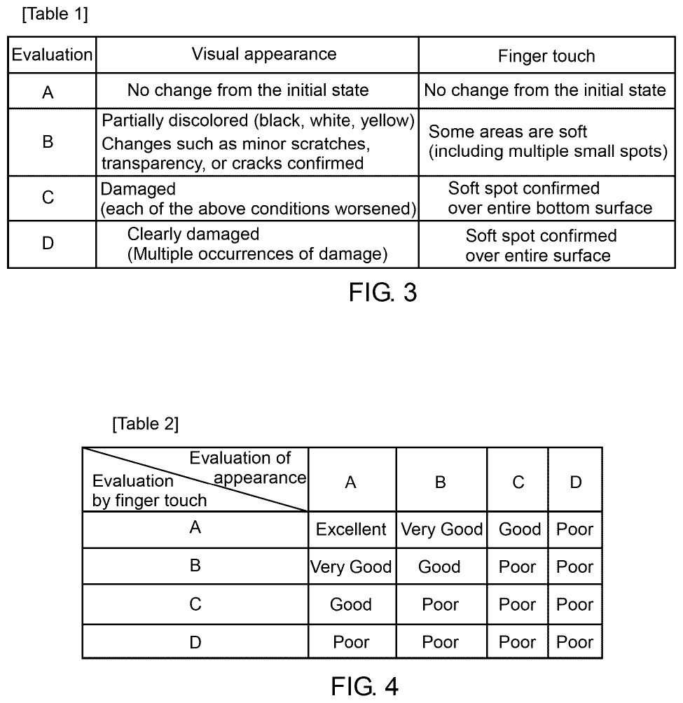

Table 1 of FIG. 3 shows the evaluation criteria for visual appearance inspection and finger touch. In addition, Table 2 of FIG. 4 shows the relationship between the visual appearance inspection evaluation, the finger touch evaluation, and the overall evaluation. The evaluation by visual appearance inspection and finger touch is indicated by A to D, and the overall evaluation is indicated by “Excellent”, “Very Good”, “Good”, or “Poor.” The test in which the overall evaluation was “Excellent”, “Very Good”, and “Good” was determined to have a practically high freshness-keeping effect.

Table 3 of FIG. 5 shows the test condition and evaluation result of Reference Example 1, Working Example 1, and Comparative Examples 1 and 2 in which tomatoes were used as test subjects. In these tests, the tomato taken from the gas bag after the first storage was subjected to the second storage (storage in a refrigerator at 5° C. for 20 days). In the first storage of Reference Example 1, a tomato that was not placed in a gas bag during the storage period was irradiated with blue LED light (4500 lx). In Comparative Examples 1 and 2, no photocatalyst layer was placed in the gas bag. In addition, in Comparative Example 2, ethylene gas diluted with air was not injected into the gas bag, but dry air was injected instead.

In Reference Example 1 and Comparative Examples 1 and 2, the overall evaluation of the freshness of the tomato after the second storage was “Poor.” On the other hand, in Working Example 1, the overall evaluation of the freshness of the tomatoes after the second storage was “Very Good”. In Working Example 1, the initial ethylene gas concentration in the gas bag in the first storage was 80 ppm, and the ethylene gas concentration in the gas bag with the photocatalyst layer irradiated with blue LED light for 3 days was 0 ppm. This is considered to be because the ethylene gas was oxidatively decomposed by the photocatalytic activity of the photocatalyst layer. It is considered that the reaction product from the oxidative decomposition of ethylene gas delayed the ripening of the tomato and suppressed the deterioration of the freshness of the tomato.

Table 4 of FIG. 6 shows the test condition and evaluation result of Reference Example 2 and Working Examples 2 to 6 in which tomatoes were used as test subjects. In Reference Example 2 and Working Examples 2 to 4 and 6, the tomato taken from the gas bag after the first storage was subjected to the third storage (storage in a refrigerator at 2° C. for 10 days or 6 days). In addition, in Working Example 5, the tomato taken from the gas bag after the first storage was subjected to the second storage (storage in a refrigerator at 26° C. for 2 days), and then subjected to the third storage (storage in a refrigerator at 2° C. for 10 days). In the first storage of Reference Example 2, a tomato that was not placed in a gas bag during the storage period was irradiated with blue LED light (4500 lx).

In Reference Example 2, the overall evaluation of the freshness of the tomatoes after the third storage was “Poor.” On the other hand, in Working Example 2 to 6, the overall evaluation of the freshness of the tomatoes after the third storage was “Very Good” or “Good.” In Working Examples 2 to 6, it is considered that the reaction product from the oxidative decomposition of ethylene gas delayed the ripening of the tomato and suppressed the deterioration of the freshness of the tomato.

Table 5 of FIG. 7 shows the test condition and evaluation result of Reference Example 3, Working Example 7, and Comparative Examples 3 and 4 in which peaches were used as test subjects. In the first storage for Working Example 7 and Comparative Examples 3 and 4, the gas in the gas bag was replaced with ethylene gas diluted with dry air every two days. In addition, the peaches taken from the gas bag after the first storage were evaluated for freshness (without being subjected to the second or third storage). In the first storage of Reference Example 3, the peach that was not placed in a gas bag during the storage period was irradiated with blue LED light (2500 lx). In Comparative Example 3, no photocatalyst layer was placed in the gas bag. In addition, in Comparative Example 4, ethylene gas was not injected into the gas bag, but dry air was injected instead.

In Reference Example 3 and Comparative Examples 3 and 4, the overall evaluation of the freshness of the peaches after the second storage was “Poor.” On the other hand, in Working Example 7, the overall evaluation of the freshness of the peaches after the first storage was “Good.” In Working Example 7, the initial ethylene gas concentration in the gas bag in the first storage was 160 ppm, and the ethylene gas concentration in the gas bag at the end of the first storage was 2 ppm. This is considered to be because the ethylene gas was oxidatively decomposed by the photocatalytic activity of the photocatalyst layer. It is considered that the reaction product from the oxidative decomposition of ethylene gas delayed the ripening of the peach and suppressed the deterioration of the freshness of the peach.

### Storage Test 2

Storage tests of Working Examples 8 and 9, Comparative Examples 5 to 7, and Reference Examples 4 and 5 were conducted to determine the number of days (freshness-keeping days) before petal detachment or bent neck occurred on roses (cultivar: Samurai 08).

First, an amount of a photocatalyst dispersion liquid (0.7 wt % Pt—WO₃ dispersion liquid) with a solid content of 0.7 g was placed in a petri dish to make the liquid layer of the photocatalyst dispersion liquid uniform in thickness. Then, the liquid layer of the photocatalyst dispersion liquid was dried at 90° C. for 1 hour to form a photocatalyst layer in the petri dish.

After the roses (cultivar: Samurai 08) were harvested, a cut end of a stem of the rose was immersed in tap water or water containing an STS agent (silver thiosulfate solution) for 6 hours to allow the cut flower (rose) to absorb water (a treatment for prolonging lives of flowers arranged or cut flowers). After the treatment, three roses whose stems were cut to a height of 40 cm were placed in a vase containing water, and these roses together with the vase were placed in a 50 L transparent acrylic box. In Working Example 8, Comparative Examples 5 and 6, and Reference Example 4, roses that had absorbed tap water were placed in an acrylic box, and in Working Example 9, Comparative Example 7, and Reference Example 5, roses that had absorbed water containing STS agent were placed in an acrylic box. In addition, in Working Examples 8 and 9 and Comparative Example 5, the petri dish having a photocatalyst layer and the blue LED (light irradiation unit) to irradiate the photocatalyst layer with light were also placed in the acrylic box. Then, the acrylic box was enclosed. Note that the acrylic box is provided with a gas inlet for introducing ethylene gas into the acrylic box. In addition, the acrylic box is provided with a gas sampling portion for measuring an ethylene gas concentration inside the acrylic box.

After the acrylic box was enclosed, in Working Examples 8 and 9 and Comparative Examples 6 and 7, ethylene gas was introduced into the acrylic box so that the ethylene gas concentration in the acrylic box was 10 ppm.

Then, for Working Examples 8 and 9, Comparative Examples 5 to 7, and Reference Examples 4 and 5, the roses were stored in the acrylic box at 25° C. until petal detachment or bent neck occurred on the roses. In Working Examples 8 and 9 and Comparative Example 5, during the storage period, the photocatalyst layer was irradiated with light from the blue LED (light irradiation unit) in 20000 lx in the acrylic box. It is considered that the ethylene gas would be decomposed by the photocatalytic activity generated by this light irradiation.

During the storage period, the illumination of the room was turned on and off so that the room having the acrylic box installed was repeatedly in a bright state (1000 lx) for 12 hours and in a dark state (except for the light from the light irradiation unit) for 12 hours.

In addition, the ethylene gas concentration in the acrylic box at the end of storage was measured.

Bent neck refers to a shape in which a peduncle portion several centimeters below a petal is bent and the flower hangs down from the neck. In the test, the peduncle portion being bent by 90 degrees or more was determined to have bent neck occurring.

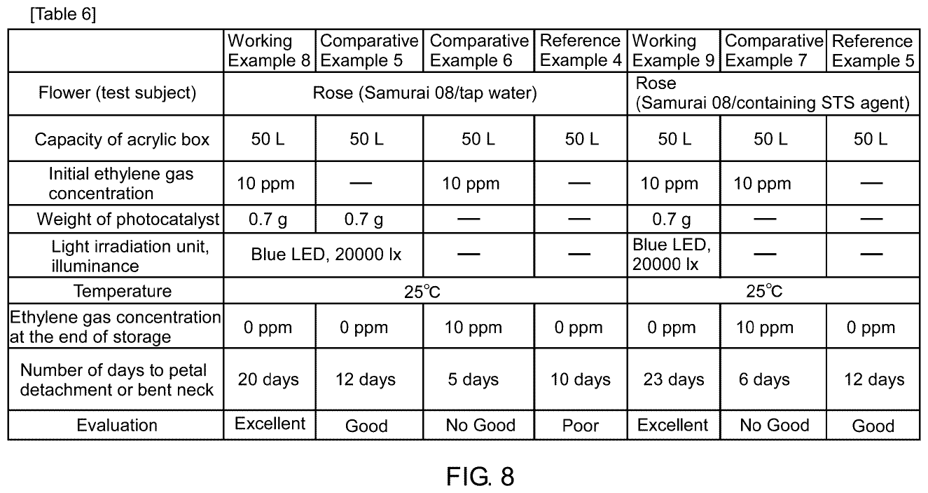

Table 6 of FIG. 8 shows the number of days to petal detachment or bent neck (number of freshness-keeping days), the ethylene gas concentration in the acrylic box at the end of storage, the evaluation on the freshness keeping of the flower, and the like.

In Table 6 of FIG. 8, the evaluation of the test in which the number of freshness-keeping days was 7 days or less is indicated by “No Good,” the evaluation of the test in which the number of freshness-keeping days was 8 days or more and 11 days or less is indicated by “Poor,” the evaluation of the test in which the number of freshness-keeping days was 12 days or more and 15 days or less is indicated by “Good,” and the evaluation of the test in which the number of freshness-keeping days was 20 days or more is indicated by “Excellent”. The evaluation of the test in which the number of freshness-keeping days was 16 days or more and 19 days or less is “Very Good,” but there was no corresponding test.

In Reference Examples 4 and 5, no ethylene gas was introduced into the acrylic box, and no photocatalyst was placed in the acrylic box. The roses stored in Reference Example 4 contained no STS agent, and the number of freshness-keeping days was 10 days. In addition, the roses stored in Reference Example 5 contained STS agent, and the number of freshness-keeping days was 12 days. From this, it was found that treating roses with STS increases the number of freshness-keeping days by about two days.

In Comparative Examples 6 and 7, ethylene gas was introduced into the acrylic box, and no photocatalyst was placed in the acrylic box. The number of freshness-keeping days in Comparative Example 6 was 5 days, and the number of freshness-keeping days in Comparative Example 7 was 6 days. The freshness-keeping periods were shorter than those in Reference Examples 4 and 5. This is considered to be because the ethylene gas introduced into the acrylic box promoted the senescence of the roses.

In Comparative Example 5, no ethylene gas was introduced into the acrylic box, and the photocatalyst in the acrylic box was irradiated with blue LED light. The number of freshness-keeping days in Comparative Example 5 was 12 days, which was longer than that in Reference Example 4 by 2 days. This is considered to be because an organic gas or the like in the acrylic box was decomposed by the photocatalytic activity.

In Working Examples 8 and 9, ethylene gas was introduced into the acrylic box, and the photocatalyst in the acrylic box was irradiated with blue LED light. The number of freshness-keeping days in Working Example 8 was 20 days, which was longer than that in Reference Example 4 by 10 days. In addition, the number of freshness-keeping days in Working Example 9 was 23 days, which was longer than that in Reference Example 5 by 11 days. This is considered to be because the ethylene gas in the acrylic box was decomposed by the photocatalytic activity, and this reaction product suppressed the progress of the senescence of the roses.

What is claimed is:

1. A storage method comprising:
a gas supply step of supplying ethylene gas into a storage, a storage vessel, or a storage bag; and
an irradiation step of irradiating a photocatalyst in the storage, the storage vessel, or the storage bag storing at least one of a vegetable, a fruit, a flower, or an ornamental plant with light, thereby decomposing the ethylene gas.

2. The storage method according to claim 1, wherein a concentration of the ethylene gas in the storage, the storage vessel, or the storage bag into which the ethylene gas is supplied is from 5 ppm to 160 ppm.

3. The storage method according to claim 2, wherein the irradiation step is a step of irradiating the photocatalyst with light at least until the ethylene gas concentration in the storage, the storage vessel, or the storage bag becomes 2 ppm or less.

4. The storage method according to claim 1, wherein the photocatalyst includes tungsten oxide.

5. A storage apparatus comprising:
a storage, a storage vessel or a storage bag for storing at least one of a vegetable, a fruit, a flower, or an ornamental plant;
a photocatalyst placed in the storage, the storage vessel or the storage bag;
a light irradiation unit provided to irradiate the photocatalyst with light; and
an ethylene gas supply unit that is provided to supply ethylene gas into the storage, the storage vessel or the storage bag.

6. A transportation method comprising:
a gas supply step of supplying ethylene gas into a cargo compartment, a transportation vessel, or a transportation bag;
an irradiation step of irradiating a photocatalyst in the cargo compartment, the transportation vessel, or the transportation bag accommodating at least one of a vegetable, a fruit, a flower, or an ornamental plant with light, thereby decomposing the ethylene gas.

7. A transportation apparatus comprising:
a cargo compartment, a transportation vessel or a transportation bag for accommodating at least one of a vegetable, a fruit, a flower or an ornamental plant;
a photocatalyst placed in the cargo compartment, the transportation vessel or the transportation bag;
a light irradiation unit that is provided to irradiate the photocatalyst with light; and
an ethylene gas supply unit that is provided to supply ethylene gas into the cargo compartment, the transportation vessel or the transportation bag.
